(19) United States
(12) Patent Application Publication
(10) Pub. No.: US 2023/0419732 A1
(43) Pub. Date: Dec. 28, 2023

(54) METHOD FOR GAIT RECOGNITION BASED ON VISIBLE LIGHT, INFRARED RADIATION AND STRUCTURED LIGHT

(71) Applicant: China Construction Industrial & Energy Engineering Group Co., Ltd., Nanjing (CN)

(72) Inventors: Shengqing YAO, Nanjing (CN); Zhizhong XIAO, Nanjing (CN); Yanfang ZHANG, Nanjing (CN); Jiaojiao NI, Nanjing (CN); Zengxiao GAO, Nanjing (CN)

(73) Assignee: China Construction Industrial & Energy Engineering Group Co., Ltd., Nanjing (CN)

(21) Appl. No.: 18/321,006

(22) Filed: May 22, 2023

(30) Foreign Application Priority Data
Jun. 27, 2022 (CN) 202210732669.4

(51) Int. Cl. G06V 40/20; G06T 7/269; H04N 19/517; G06T 7/80

(52) U.S. Cl. CPC G06V 40/25; G06T 7/269; H04N 19/517; G06T 7/80; G06T 2207/10048; G06T 2207/20221; G06T 2207/30008; G06F 17/15

(57) ABSTRACT

The present disclosure provides a method for gait recognition based on visible light, infrared radiation and structured light. According to the method, three types of raw image data are obtained from a visible light sensor, an infrared sensor, and a structured light sensor, then image processing and multi-sensor image fusion are improved to obtain a fused image, and gait recognition is performed based on the fused image. The method effectively improves the robustness of a recognition algorithm, and can realize accurate identification of individuals under various extreme conditions. The method has good adaptability and has a broad application prospect.

### CROSS-REFERENCE TO RELATED APPLICATIONS

This application claims priority to Chinese Patent Application No. 202210732669.4 with a filing date of Jun. 27, 2022. The content of the aforementioned application, including any intervening amendments thereto, is incorporated herein by reference.

### TECHNICAL FIELD

The present disclosure belongs to the field of intelligent recognition technologies, and in particular, relates to a method for gait recognition based on visible light, infrared radiation and structured light.

### BACKGROUND

Gait is a pattern of movements during walking, which is a complex behavioral characteristic. As everyone's gait is different, gait can be used as new biometric information for identifying individuals. Gait information differs greatly from other biometric information in data collection and processing. A current gait recognition technology typically relies on acquiring data of a single visible light image for analysis and recognition. However, this conventional gait recognition technology will be restricted in situations such as a poor lighting condition, a limited sensor position, and a long distance, as individuals cannot be identified by using only visible light images. In view of the above problems, it is urgent to study a new gait recognition technology with better adaptability.

### SUMMARY OF PRESENT INVENTION

An objective of the present disclosure is to provide a method for gait recognition based on visible light, infrared radiation and structured light. By improving image processing methods and combining multiple sensors, the robustness of a recognition algorithm is fully improved, and the problem in an existing recognition technology that individuals cannot be accurately identified under various extreme conditions are resolved.

The present disclosure achieves the above technical objective through following technical solutions.

A method for gait recognition based on visible light, infrared radiation and structured light, includes the following steps:
step 1: obtaining three types of raw data from a visible light sensor, an infrared sensor, and a structured light sensor for preprocessing to obtain three types of image data with a consistent spatial mapping relationship, wherein the three types of image data comprises visible light data, infrared data and structured light data;
step 2: encoding the visible light data into Y, U, and V channels based on a YUV encoding space, encoding the infrared data into a T channel, and encoding the structured light data into a depth channel;
step 3: using two-dimensional Laplace transform to solve isotropic second-order derivatives of eight adjacent pixels in front, back, left and right directions of each pixel in the depth channel, and adding the second-order derivatives to obtain a new value of the pixel;
step 4: for the depth channel processed in step 3, performing convolution operations by using two convolution operators, to determine a gradient vector, a gradient strength, and a gradient direction of each pixel;
step 5: using the gradient vector to generate two mutually inverse feature convolution kernels, and using the two feature convolution kernels as weights to perform convolution operations on 3×3 regions of pixels at a corresponding pixel position in the four channels of Y, U, V, and T, so as to obtain eight feature weight maps;
step 6: calculating a similarity between eight values of a same pixel position in the eight feature weight maps;
step 7: setting similarity thresholds, and obtaining a corresponding fused image based on a similarity degree of each pixel; and
step 8: extracting human head information and human skeleton information in the fused image, extracting a gait feature based on the human skeleton information, extracting a gait feature based on a normalized YUV visible light flow, and combining the two gait features for gait recognition.

Preferably, the new value of the pixel in step 3 is obtained according to the following formula:

$${∇}^{2} f ( x , y ) = \frac{{\partial }^{2} f}{\partial {v}_{1}^{2}} + \frac{{\partial }^{2} f}{\partial {v}_{2}^{2}} + \frac{{\partial }^{2} f}{\partial {v}_{3}^{2}} + \frac{{\partial }^{2} f}{\partial {v}_{4}^{2}}$$

where ∇²ƒ(x, y) represents second-order partial derivative processing performed on a function ƒ(x, y); (x, y) represents coordinates of the pixel, x is the abscissa, and y is the ordinate; ∂ represents a partial derivative symbol; ƒ represents ƒ(x, y); and υ₁, υ₂, υ₃, and υ₄ represent unit vectors of four directions of 0°, 90°, 180°, and 270° respectively.

Preferably, the gradient strength and the gradient direction in step 4 are calculated according to the following formula:

$${G}_{x} = [ \begin{matrix}- 1 & 0 & 1 \\ - 2 & 0 & 2 \\ - 1 & 0 & 1\end{matrix} ]$$

$${G}_{y} = [ \begin{matrix}- 1 & - 2 & - 1 \\ 0 & 0 & 0 \\ 1 & 2 & 1\end{matrix} ]$$

$${G}_{{D}_{( x , y )}} = \sqrt{{G}_{x}^{2} + {G}_{y}^{2}}$$

$${θ}_{{D}_{( x , γ )}} = {tan}^{- 1} \frac{{G}_{y}}{{G}_{x}}$$

where Gₓ and G_{y} both represent convolution operators; G_{D}_{_{(x,y)}} represents the gradient strength of pixel (x, y); and θ_{D}_{_{(x,y)}} represents the gradient direction of pixel (x, y).

Preferably, two mutually inverse feature convolution kernels G1_{(x,y)} and G2_{(x,y)} in step 5 are as follows:

$$G {1}_{( x , y )} = [ \begin{matrix}{G}_{{D}_{( x , y )}} sin ( {θ}_{{D}_{( x , y )}} - \frac{π}{4} ) & {G}_{{D}_{( x , y )}} sin {θ}_{{D}_{( x , y )}} & {G}_{{D}_{( x , y )}} cos ( {θ}_{{D}_{( x , y )}} - \frac{π}{4} ) \\ - {G}_{{D}_{( x , y )}} cos {θ}_{{D}_{( x , y )}} & 1 & {G}_{{D}_{( x , y )}} cos {θ}_{{D}_{( x , y )}} \\ - {G}_{{D}_{( x , y )}} cos ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} sin ( {θ}_{{D}_{( x , y )}} - \frac{π}{4} )\end{matrix} ]$$

$$G {2}_{( x , y )} = [ \begin{matrix}- {G}_{{D}_{( x , y )}} sin ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} cos ( {θ}_{{D}_{( x , y )}} - \frac{π}{4} ) \\ {G}_{{D}_{( x , y )}} cos {θ}_{{D}_{( x , y )}} & 1 & - {G}_{{D}_{( x , y )}} cos {θ}_{{D}_{( x , y )}} \\ {G}_{{D}_{( x , y )}} cos ( {θ}_{{D}_{( x , y )}} - \frac{π}{4} ) & {G}_{{D}_{( x , y )}} sin {θ}_{{D}_{( x , y )}} & {G}_{{D}_{( x , y )}} sin ( {θ}_{{D}_{( x , y )}} - \frac{π}{4} )\end{matrix} ]$$

Where G_{D}_{_{(x,y)}} represents the gradient strength of pixel (x, y); and θ_{D}_{_{(x,y)}} represents the gradient direction of pixel (x, y).

Preferably, the similarity in step 6 is calculated according to the following formula:

$$S ( x , y ) = \frac{\sqrt[8]{{\prod }_{i = 1}^{8} {C}_{i} ( x , y )}}{\frac{{\sum }_{i = 1}^{8} {C}_{i} ( x , y )}{8}}$$

where S(x, y) represents the similarity at a pixel position with the abscissa of x and the ordinate of y; i represents a variable parameter, indicating a serial number of a feature weight map; Cᵢ(x, y) represents a parameter of a pixel with the abscissa of x and the ordinate of y in an ith feature weight map.

Preferably, the similarity in step 7 thresholds are T₁ and T₂, and T₁<T₂; when S(x, y)<T₁, a fused image A(x, y)=Cᵢ(x,y)ₘₐₓ; when T₁≤S(x, y)≤T₂, a fused image A(x, y)=an average of top four Cᵢ(x, y) with greatest values; and when T₂≤S(x, y), a fused image

$$A ( x , y ) = \frac{{\sum }_{i = 1}^{8} {C}_{i} ( x , y )}{8} ,$$

where S(x, y) represents a similarity at a pixel position with the abscissa of x and the ordinate of y; Cᵢ(x, y) represents a parameter of a pixel with the abscissa of x and the ordinate of y in an ith feature weight map; i represents a variable parameter, indicating a serial number of a feature weight map; Cᵢ(x, y)ₘₐₓ represents a maximum value of the parameter of the pixel with the abscissa of x and the ordinate of y in the ith feature weight map.

Preferably, the preprocessing in step 1 includes intrinsic calibration, extrinsic calibration, cropping, and normalization.

The present disclosure has the following beneficial effects.

The present disclosure proposes a method for gait recognition based on visible light, infrared radiation and structured light. According to the method, image data required by three detection devices are fused, and gait recognition is performed based on the fused image. The method improves image processing and multi-sensor image fusion, effectively improves the robustness of a recognition algorithm, and can realize accurate identification of individuals under various extreme conditions.

### BRIEF DESCRIPTION OF THE DRAWINGS

FIG. 1 is a flowchart of a method for gait recognition according to the present disclosure.

### DETAILED DESCRIPTION OF THE EMBODIMENTS

The present disclosure will be further described below in conjunction with the accompanying drawings and specific embodiments, but the protection scope of the present disclosure is not limited thereto.

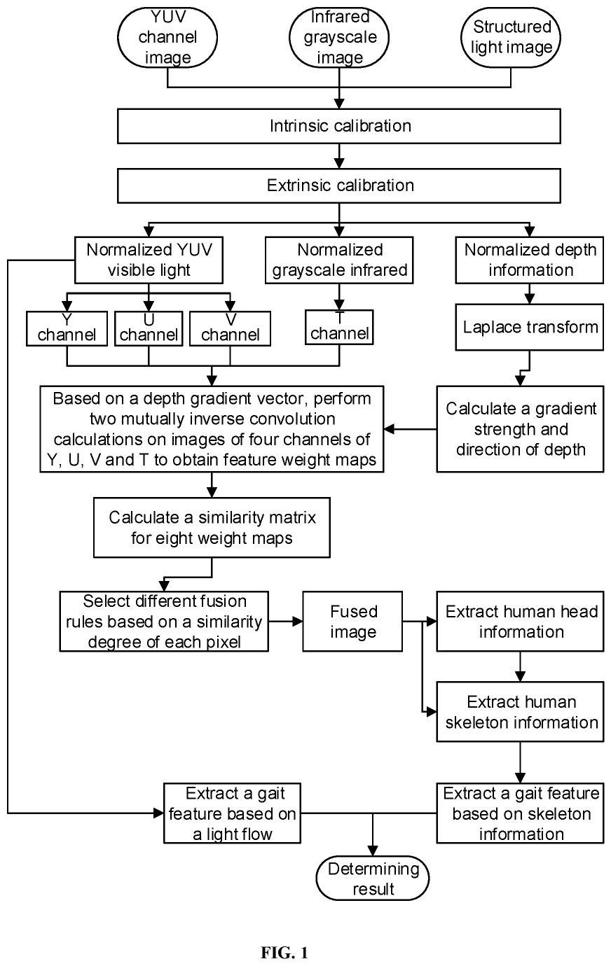

A method for gait recognition based on visible light, infrared radiation and structured light according to the present disclosure is shown in FIG. 1, and specifically includes the following steps:

Step 1: Obtain three types of raw data from a visible light sensor, an infrared sensor, and a structured light sensor, where the three types of raw data include YUV channel data, infrared grayscale image data, and structured light image data.

Step 2: Perform intrinsic calibration, extrinsic calibration, cropping, and normalization on the raw data to obtain three types of image data with a consistent spatial mapping relationship, wherein the three types of image data comprises visible light data, infrared data and structured light data.

Step 3: Encode the visible light data processed in step 2 into Y, U, and V channels based on a YUV encoding space, encode the processed infrared data into a T channel, and encode the processed structured light data into a depth channel.

Step 4: Use two-dimensional Laplace transform to solve isotropic second-order derivatives of eight adjacent pixels in front, back, left and right directions of each pixel in the depth channel, and add the second-order derivatives to obtain a of new value of the pixel. Specifically:

$${∇}^{2} f ( x , y ) = \frac{{\partial }^{2} f}{\partial {v}_{1}^{2}} + \frac{{\partial }^{2} f}{\partial {v}_{2}^{2}} + \frac{{\partial }^{2} f}{\partial {v}_{3}^{2}} + \frac{{\partial }^{2} f}{\partial {v}_{4}^{2}}$$

where ∇²ƒ(x, y) represents second-order partial derivative processing performed on a function ƒ(x, y); (x, y) represents coordinates of the pixel, where x is the abscissa, and y is the ordinate; ∂ represents a partial derivative symbol; ƒ represents ƒ(x, y); and υ₁, υ₂, υ₃, and υ₄ represent unit vectors of four directions of 0°, 90°, 180°, and 270° respectively.

Step 5: For the depth channel processed by the Laplace transform in step 4, perform convolution operation by using two convolution operators Gₓ and G_{y} to determine a gradient vector A_{D}_{_{(x,y)}}(G_{D}_{_{(x,y)}}, θ_{D}_{_{(x,y)}}) of each pixel, where A_{D}_{_{(x,y)}} represent a gradient vector of pixel (x, y), G_{D}_{_{(x,y)}} represent a gradient strength of pixel (x, y), θ_{D}_{_{(x,y)}} represent a gradient direction of pixel (x, y), and the gradient strength and the gradient direction of are calculated according to the following formula:

$${G}_{x} = [ \begin{matrix}- 1 & 0 & 1 \\ - 2 & 0 & 2 \\ - 1 & 0 & 1\end{matrix} ]$$

$${G}_{y} = [ \begin{matrix}- 1 & - 2 & - 1 \\ 0 & 0 & 0 \\ 1 & 2 & 1\end{matrix} ]$$

$${G}_{{D}_{( x , y )}} = \sqrt{{G}_{x}^{2} + {G}_{y}^{2}}$$

$${θ}_{{D}_{( x , y )}} = {tan}^{- 1} \frac{{G}_{y}}{{G}_{x}}$$

Step 6: Use the gradient vector obtained from the depth channel to generate two mutually inverse feature convolution kernels G1_{(x,y)} and G2_{(x,y)}:

$$G {1}_{( x , y )} = [ \begin{matrix}{G}_{{D}_{( x , y )}} sin ( {θ}_{{D}_{( x , y )}} - \frac{π}{4} ) & {G}_{{D}_{( x , y )}} sin {θ}_{{D}_{( x , y )}} & {G}_{{D}_{( x , y )}} cos ( {θ}_{{D}_{( x , y )}} - \frac{π}{4} ) \\ - {G}_{{D}_{( x , y )}} cos {θ}_{{D}_{( x , y )}} & 1 & {G}_{{D}_{( x , y )}} cos {θ}_{{D}_{( x , y )}} \\ - {G}_{{D}_{( x , y )}} cos ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} sin ( {θ}_{{D}_{( x , y )}} - \frac{π}{4} )\end{matrix} ]$$

$$G {2}_{( x , y )} = [ \begin{matrix}- {G}_{{D}_{( x , y )}} sin ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} cos ( {θ}_{{D}_{( x , y )}} - \frac{π}{4} ) \\ {G}_{{D}_{( x , y )}} cos {θ}_{{D}_{( x , y )}} & 1 & - {G}_{{D}_{( x , y )}} cos {θ}_{{D}_{( x , y )}} \\ {G}_{{D}_{( x , y )}} cos ( {θ}_{{D}_{( x , y )}} - \frac{π}{4} ) & {G}_{{D}_{( x , y )}} sin {θ}_{{D}_{( x , y )}} & {G}_{{D}_{( x , y )}} sin ( {θ}_{{D}_{( x , y )}} - \frac{π}{4} )\end{matrix} ]$$

The two feature convolution kernels G1_{(x,y)} and G2_{(x,y)} are used as weights to perform convolution operations on 3×3 regions of pixels at a corresponding pixel (x, y) position in the four channels of Y, U, V, and T, so as to obtain eight feature weight maps.

Step 7: Calculate a similarity between eight values of a same pixel position in the eight feature weight maps as follows:

$$S ( x , y ) = \frac{\sqrt[8]{{\prod }_{i = 1}^{8} {C}_{i} ( x , y )}}{\frac{{\sum }_{i = 1}^{8} {C}_{i} ( x , y )}{8}}$$

where S(x, y) represents the similarity at a pixel position with the abscissa of x and the ordinate of y; i represents a variable parameter, indicating a serial number of a feature weight map; Cᵢ(x, y) represents a parameter of a pixel with the abscissa of x and the ordinate of y in an ith feature weight map.

Step 8: Set similarity thresholds T₁ and T₂ and T₁<T₂, and obtain a corresponding fused image by selecting different fusion rules based on a similarity degree of each pixel; where
when S(x, y)<T₁, a fused image A(x, y)=Cᵢ(x,y)ₘₐₓ;
when T₁≤S(x, y)≤T₂, a fused image A(x, y)=an average of top four Cᵢ(x, y) with greatest values; and
when T₂≤S(x, y), a fused image

$$A ( x , y ) = \frac{{\sum }_{i = 1}^{8} {C}_{i} ( x , y )}{8} .$$

Step 9: Extract human head information in the fused image by using the YOLO algorithm, and then extract human skeleton information in the fused image based on the Alphapose method.

Step 10: Extract a gait feature based on the human skeleton information, extract a gait feature based on a normalized YUV visible light flow, and combine the two gait features for gait recognition.

The above embodiments are preferred implementations of the present disclosure, but the present disclosure is not limited to the above implementations. Any obvious improvement, substitution, or modification made by those skilled in the art without departing from the essence of the present disclosure should fall within the protection scope of the present disclosure.

1: A method for gait recognition based on visible light, infrared radiation and structured light, comprising the following steps:
step 1: operating a visible light sensor, an infrared sensor, and a structured light sensor to detect a gait of a subject so as to respectively obtain three types of raw data of the gait of the subject and preprocessing the three types of raw data to respectively obtain three types of image data with a consistent spatial mapping relationship, wherein the detection of the gait of the subject is performed with visible light, infrared radiation, and structured light that are different from each other, and the three types of image data comprise visible light data, infrared data and structured light data;
step 2: encoding the visible light data into Y, U, and V channels based on a YUV encoding space, encoding the infrared data into a T channel, and encoding the structured light data into a depth channel;
step 3: using two-dimensional Laplace transform to solve isotropic second-order derivatives of eight adjacent pixels in front, back, left and right directions of each pixel in the depth channel, and adding the second-order derivatives to obtain a new value of the pixel;
step 4: for the depth channel processed in step 3, performing convolution operations by using two convolution operators, to determine a gradient vector, a gradient strength, and a gradient direction of each pixel;
step 5: using the gradient vector to generate two mutually inverse feature convolution kernels, and using the two feature convolution kernels as weights to perform convolution operations on 3×3 regions of pixels at a corresponding pixel position in the four channels of Y, U, V, and T, so as to obtain eight feature weight maps;
step 6: calculating a similarity between eight values of a same pixel position in the eight feature weight maps;
step 7: setting similarity thresholds, and obtaining a corresponding fused image based on a similarity degree of each pixel; and
step 8: extracting human head information and human skeleton information of the subject in the fused image, extracting a gait feature based on the human skeleton information, extracting a gait feature based on a preprocessed YUV visible light flow, and combining the two gait features for gait recognition;
wherein the new value of the pixel in step 3 is obtained according to the following formula:
$${∇}^{2} f ( x , y ) = \frac{{\partial }^{2} f}{\partial {v}_{1}^{2}} + \frac{{\partial }^{2} f}{\partial {v}_{2}^{2}} + \frac{{\partial }^{2} f}{\partial {v}_{3}^{2}} + \frac{{\partial }^{2} f}{\partial {v}_{4}^{2}}$$
∇²ƒ(x, y) represents second-order partial derivative processing performed on a function ƒ(x, y); (x, y) represents coordinates of the pixel, x is the abscissa, and y is the ordinate; ∂ represents a partial derivative symbol; ƒ represents ƒ(x, y); and υ₁, υ₂, υ₃, and υ₄ represent unit vectors of four directions of 0°, 90°, 180°, and 270° respectively.

2: The method according to claim 1, wherein the gradient strength and the gradient direction in step 4 are calculated according to the following formula:
$${G}_{x} = [ \begin{matrix}- 1 & 0 & 1 \\ - 2 & 0 & 2 \\ - 1 & 0 & 1\end{matrix} ]$$
$${G}_{y} = [ \begin{matrix}- 1 - 2 & - 1 \\ 00 & 0 \\ 12 & 1\end{matrix} ]$$
$${G}_{{D}_{( x , y )}} = \sqrt{{G}_{x}^{2} + {G}_{y}^{2}}$$
$${θ}_{{D}_{( x , y )}} = {tan}^{- 1} \frac{{G}_{y}}{{G}_{x}}$$
Gₓ and G_{y} both represent convolution operators; G_{D}_{_{(x,y)}} represents the gradient strength of pixel (x, y); and θ_{D}_{_{(x,y)}} represents the gradient direction of pixel (x, y).

3: The method according to claim 1, wherein two mutually inverse feature convolution kernels G1_{(x,y)} and G2_{(x,y)} in step 5 are as follows:
$$G {1}_{( x , y )} = [ \begin{matrix}{G}_{{D}_{( x , y )}} sin ( {θ}_{{D}_{( x , y )}} - \frac{π}{4} ) & {G}_{{D}_{( x , y )}} sin {θ}_{{D}_{( x , y )}} & {G}_{{D}_{( x , y )}} cos ( {θ}_{{D}_{( x , y )}} - \frac{π}{4} ) \\ - {G}_{{D}_{( x , y )}} cos {θ}_{{D}_{( x , y )}} & 1 & {G}_{{D}_{( x , y )}} cos {θ}_{{D}_{( x , y )}} \\ - {G}_{{D}_{( x , y )}} cos ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} sin ( {θ}_{{D}_{( x , y )}} - \frac{π}{4} )\end{matrix} ]$$
$$G {2}_{( x , y )} = [ \begin{matrix}- {G}_{{D}_{( x , y )}} sin ( {θ}_{{D}_{( x , y )}} - \frac{π}{4} ) & - {G}_{{D}_{( x , y )}} sin {θ}_{{D}_{( x , y )}} & - {G}_{{D}_{( x , y )}} cos ( {θ}_{{D}_{( x , y )}} - \frac{π}{4} ) \\ {G}_{{D}_{( x , y )}} cos {θ}_{{D}_{( x , y )}} & 1 & - {G}_{{D}_{( x , y )}} cos {θ}_{{D}_{( x , y )}} \\ {G}_{{D}_{( x , y )}} cos ( {θ}_{{D}_{( x , y )}} - \frac{π}{4} ) & {G}_{{D}_{( x , y )}} sin {θ}_{{D}_{( x , y )}} & {G}_{{D}_{( x , y )}} sin ( {θ}_{{D}_{( x , y )}} - \frac{π}{4} )\end{matrix} ]$$
G_{D}_{_{(x,y)}} represents the gradient strength of pixel (x, y); and θ_{D}_{_{(x,y)}} represents the gradient direction of pixel (x, y).

4: The method according to claim 1, wherein the similarity in step 6 is calculated according to the following formula:
$$S ( x , y ) = \frac{\sqrt[8]{{\prod }_{i = 1}^{8} {C}_{i} ( x , y )}}{\frac{{\sum }_{i = 1}^{8} {C}_{i} ( x , y )}{8}}$$
S(x, y) represents the similarity at a pixel position with the abscissa of x and the ordinate of y; i represents a variable parameter, indicating a serial number of a feature weight map; Cᵢ(x, y) represents a parameter of a pixel with the abscissa of x and the ordinate of y in an ith feature weight map.

5: The method according to claim 1, wherein the similarity thresholds in step 7 are T₁ and T₂, and T₁<T₂;
If S(x, y)<T₁, a fused image A(x, y)=Cᵢ(x, y)ₘₐₓ;
if T₁≤S(x, y)≤T₂, a fused image A(x, y)=an average of top four Cᵢ(x, y) with greatest values;
if T₂<S(x, y), a fused image
$$A ( x , y ) = \frac{{\sum }_{i = 1}^{8} {C}_{i} ( x , y )}{8} ;$$
wherein
S(x, y) represents the similarity at a pixel position with the abscissa of x and the ordinate of y; Cᵢ(x, y) represents a parameter of a pixel with the abscissa of x and the ordinate of y in an ith feature weight map; i represents a variable parameter, indicating a serial number of a feature weight map; Cᵢ(x, y)ₘₐₓ represents a maximum value of the parameter of the pixel with the abscissa of x and the ordinate of y in the ith feature weight map.

6: The method according to claim 1, wherein the preprocessing in step 1 comprises intrinsic calibration, extrinsic calibration, cropping, and normalization.
